(19) United States
(12) Patent Application Publication
(10) Pub. No.: US 2014/0178527 A1
(43) Pub. Date: Jun. 26, 2014

(54) NUTRIENT-DENSE MULTIPLEX COMESTIBLES

(71) Applicant: LUBY'S FUDDRUCKERS RESTAURANTS, LLC, Houston, TX (US)

(72) Inventors: Daniel Phalen, Houston, TX (US); Jamille Bond, Houston, TX (US)

(73) Assignee: LUBY'S FUDDRUCKERS RESTAURANTS, LLC, HOUSTON, TX (US)

(21) Appl. No.: 13/725,762

(22) Filed: Dec. 21, 2012

(51) Int. Cl. A23L 1/29

(52) U.S. Cl. CPC A23L 1/296
USPC 426/2; 426/639; 426/629; 426/632

(57) ABSTRACT

Provided herein are nutrient-dense multiplex comestibles as well as methods of their use and processes to produce such multiplex comestibles.

### SUMMARY OF THE INVENTION

Disclosed herein, in some embodiments, is a multiplex comestible product comprising the following components: i) a chocolate flavoring; ii) an aqueous solution comprising homogenization of desiccated prunus domestica; and iii) an additional item selected from homogenized persea americana, and/or the aleurone and pericarp of a grain; and iv) a sweetener; wherein the product is severable into at least about twenty apportionments of from 200 to 400 kilocalories, wherein each apportionment of the product comprises one or more of the following: a) at least about two grams of fiber; and b) at least about 2 milligrams of vitamin C. In some embodiments, the additional item is homogenized persea americana. In some embodiments, the additional item is the aleurone and pericarp of a grain. In some embodiments, each apportionment comprises at least about three grams of fiber. In some embodiments, each apportionment comprises from 200 to 350 kilocalories. In some embodiments, the product is exposed to a temperature of at least about 160° C. for at least about ten minutes.

Disclosed herein, in some embodiments, is a multiplex comestible product comprising: i) a chocolate flavoring; ii) an aqueous solution comprising homogenization of Malus domestica; iii) homogenized Phaseolus vulgaris; and iv) a sweetener; wherein the product is severable into at least about twenty apportionments of from 200 to 400 kilocalories, wherein each apportionment of the product comprises one or more of the following: d) at least about two grams of fiber; and e) at least about 5 milligrams of vitamin C; and f) at least about 5 grams of protein. In some embodiments, each apportionment comprises at least about 6 grams of protein. In some embodiments, each apportionment comprises at least about 6 milligrams of Vitamin C. In some embodiments, the product is exposed to a temperature of at least about 160° C. for at least about ten minutes. In some embodiments, the product further comprises a homogenization of arachis hypogaea.

Also disclosed herein is a process for producing a multiplex comestible product comprising admixing the following components: i) a chocolate flavoring; ii) an aqueous solution comprising homogenization of desiccated prunus domestica; and iii) an additional item selected from homogenized persea americana, and/or the aleurone and pericarp of a grain; and iv) a sweetener; and severing the product into at least about twenty apportionments of from 200 to 400 kilocalories, such that each apportionment of the product comprises one or more of the following: a) at least about two grams of fiber; and b) at least about 2 milligrams of vitamin C. In some embodiments, the additional item is homogenized persea americana. In some embodiments, the additional item is the aleurone and pericarp of a grain. In some embodiments, each apportionment comprises at least about three grams of fiber. In some embodiments, each apportionment comprises from 200 to 350 kilocalories.

Also disclosed herein is a method of increasing fiber intake in an individual in need thereof comprising administering a multiplex comestible product, as disclosed herein. In some embodiments, the individual is below the age of 18 years or above the age of 65 years.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### DETAILED DESCRIPTION OF THE INVENTION

Nutrient-dense comestible products provide minerals, vitamins, and other substances that, in some embodiments, have positive health effects, with relatively few calories. In some embodiments, disclosed herein are nutrient-dense comestible products that are lean or low in solid fats, and minimize or exclude added sugars, and added refined starches, as these add calories but few essential nutrients or dietary fiber. In some embodiments, nutrient-dense comestible products also minimize or exclude added salt or other compounds high in sodium. In some embodiments, disclosed herein are nutrient-dense comestible products that have higher levels of dietary fiber, compared to similar non-nutrient dense comestible products. All fat-free or low-fat milk and milk products, vegetables, fruits, whole grains, seafood, lean meats and poultry, eggs, beans and peas (legumens), and nuts and seeds that are prepared without added sugars, solid fats, starches, and sodium are nutrient-dense.

Most vegetables and fruits are major contributors of a number of nutrients that are underconsumed in the United States, including folate, magnesium, potassium, dietary fiber, and vitamins A, C, and K.

Consumption of fruits and vegetables is associated with reduced risk of many chronic diseases. It has been shown that intake of at least 21/2 cups of vegetables and fruits per day is associated with a reduced risk of cardiovascular disease, including heart attack and stroke. In some embodiments, vegetables and fruits are protective against certain types of cancer.

Most vegetables and fruits, when prepared without added sugars or fats, are relatively low in calories. Eating higher levels of fruits and vegetables instead of higher calorie foods can help children and adults achieve and maintain a healthy weight. However, for almost all Americans ages 2 years and older, usual intake of vegetables and fruits falls below recommended amounts.

### Fiber

Fiber is the non-digestible carbohydrates and lignin that are intrinsic and intact in plants. Fiber consists of dietary fiber (the fiber naturally occurring in foods) and functional fiber, which are isolated, nondigestible carbohydrates that have beneficial physiological effects in humans. Sources of dietary fiber include vegetables, fruits, whole grains, and nuts. Dietary fiber helps provide a feeling of fullness and is important in promoting healthy laxation.

A low-fiber diet has been linked to numerous diseases and disorders, such as gastrointestinal disease (e.g., constipation, diverticulosis, irritable bowel syndrome), cancer, coronary heart disease, diabetes, hyperlipidemia, and obesity.

The adequate intake (AI) for fiber is 14 grams per 1,000 calories, or 25 grams per day for women and 38 grams per day for men. For children, ages 3 to 18 years, the recommended daily intake of dietary fiber is equal to the child's age plus five. Bread products made with refined flour are not high in dietary fiber, but currently contribute substantially to dietary fiber consumption because of their ubiquity in typical American diets. In some embodiments, an increase in the consumption of beans and peas, other vegetables, fruits, whole grains, and other foods with naturally occurring dietary fiber in an individual contributes to the individual meeting the recommendation for adequate daily intake of fiber.

### Vitamin A

Vitamin A is a fat-soluble vitamin that is naturally present in many foods. There are two different types of vitamin A: preformed vitamin A and provitamin A. Preformed vitamin A is found in meat, poultry, fish and dairy products. Provitamin A, also known as beta-carotene, is found in fruits (e.g., cantaloupe, apricots, and mangos), vegetables (e.g., green leafy vegetables and other green, orange, and yellow vegetables such as broccoli, carrots, and squash) and other plant-based products.

Vitamin A is important for normal vision, immune function, reproduction, and cellular communication. Vitamin A also supports cell growth and differentiation, impacting the normal formation and maintenance of the heart, lungs, kidneys, and other organs.

Deficiency in vitamin A intake can manifest in xerophthalmia (inability to see in low light) as well as a diminished ability to fight off infection. Research has shown that high consumption of foods containing beta-carotene may lead to lower risk of certain types of cancer, such as lung cancer or prostate cancer. Vitamin A supplementation is used to treat severe measles in pediatric patients as well as age-related macular degeneration.

The USDA recommends a Daily Value (DV) of 5,000 IU (international units) of vitamin A for adults and children aged 4 years and older.

### Vitamin C

Vitamin C, also known as ascorbic acid, is a water-soluble nutrient found in some foods. Vitamin C has antioxidant activity, assists in the production of collagen, improves the absorption of iron from plant-based foods, and helps the immune system to protect the body from disease.

Fruits and vegetables are the best sources of vitamin C. Such fruits and vegetables include citrus fruits (e.g., oranges and grapefruit), red and green peppers, kiwifruit, broccoli, strawberries, cantaloupe, and tomatoes.

Vitamin C deficiency can lead to anemia, bleeding gums, dry and splitting hair, gingivitis, swollen joints, increased tendency to bruise, and increased susceptibility to infection. Severe vitamin C deficiency can lead to scurvy.

Daily recommended amounts of vitamin C depend on age. Children under 18 years of age should get 15-75 milligrams of vitamin C. Adults should get 75-90 milligrams of vitamin C.

### Vitamin K

Vitamin K is a fat-soluble vitamin mostly found in vegetables, especially green vegetables such as kale, collards, spinach, broccoli, and cabbage. Vitamin K is involved with normal blood clotting and is important in the production of bone proteins.

Vitamin K deficiency can lead bleeding of the gums, nose bleeds, heavy menstrual bleeding, increased tendency to bruise, hemorrhaging, and anemia. In some instances, vitamin K deficiency leads to excessive calcium deposition in soft tissues, hardening arteries. Consequently, prolonged deficiency in vitamin K results in osteoporosis and/or coronary heart disease.

Daily recommended amounts of vitamin K for adequate intake are 120 micrograms/day for male adults, 90 micrograms/day for female adults, 15-100 micrograms/day for children and adolescents, and 10-20 micrograms/day for infants.

### Methods of Use

It is estimated that by the year 2050, 20% of the American population will be 65 or older. Older adults have decreased energy needs, mainly due to muscle mass decrease and changes in metabolism and appetite. In addition, concomitant conditions of cognitive impairment and functional limitations may adversely affect nutritional status for the elderly. Overall, these circumstances hinder the intake of fiber rich food in older adults. The intake for most Americans, including those aged 70 years or older, is 14-16 grams/day [T. S. Dharmarajan; J. Ravunniarath; C. S. Pitchumoni. Practical Gastroenterology (Feb 2003), 43-58].

In addition, in many instances, children are finicky eaters, refusing to taste or eat items presented to them at mealtimes. Texture, taste, and appearance of these food items play major roles as to why children reject certain foods, such as vegetables. As a result, achieving and maintaining a balanced diet for children can be a challenging task. This can be especially trying in a hospital setting, where injured or sick children really need adequate nutrition in order to regain health. In some embodiments, the nutrient-dense multiplex comestible products as disclosed herein serve as a source of additional full or partial servings of fruits and/or vegetables when offered as a dessert. These products obscure the appearance and taste of the homogenized fruits and/or vegetables, making it more likely that these products are consumed.

One embodiment provides a method of increasing fiber intake in an individual in need thereof comprising administering a multiplex comestible product as described herein to the individual. Another embodiment provides a method wherein the individual is below the age of 18 years or above the age of 65 years. Another embodiment provides a method wherein the individual is below the age of 18 years. Another embodiment provides a method wherein the individual is at or above the age of 65 years.

### Definitions

The term “homogenize” as used herein describes the action of reducing to fairly uniform consistency. In some embodiments, homogenization of diverse elements also leads to even distribution of the resultant small particles. Homogenization includes pureeing, grinding and grating. In some embodiments, homogenization is performed using electrical or hand-operated equipment, such as a blender, a food processor, or a mixer. In some embodiments, homogenization is performed by hand, with or without hand-operated tools or equipment. In some embodiments, homogenization is performed by a combination of actions by hand and by electrical and/or hand-operated tools or equipment. “Partial homogenization” refers to reduction to non-uniform smaller size. Partial homogenization includes shredding, tearing, cutting, splitting, chopping, dicing, and crumbling. In some embodiments, partial homogenization of diverse elements leads to uneven distribution of non-uniformly smaller sized elements. In some embodiments, homogenization or partial homogenization of a component is performed before the application of any temperature change to the component, such as heating, boiling, steaming, baking, roasting, sautéing, or frying. In some embodiments, homogenization or partial homogenization is performed after the application of any temperature change.

The term “flavoring” describes a food material that imparts a flavor when used during the preparation of a dish. Non-limiting examples of flavoring include spices, salt, pepper, fruit juice, oils, pastes, sauces, artificial flavoring, and plant extracts.

The term “chocolate flavoring” describes a food material that imparts a flavor that arises from a cacao bean-derived component. In some embodiments, chocolate flavoring comprises cocoa solids and/or cocoa butter that have been extracted from the cacao bean.

### Nutrient-Dense Comestible Products

One embodiment provides a multiplex comestible product comprising the following components:
a. a chocolate flavoring;
b. an aqueous solution comprising homogenization of desiccated prunus domestica;
c. an additional item selected from homogenized persea americana, and/or the aleurone and pericarp of a grain; and
d. a sweetener;
   wherein the product is severable into at least about twenty apportionments of from 200 to 400 kilocalories, wherein each apportionment of the product comprises one or more of the following:
a) at least about two grams of fiber; and
b) at least about 2 milligrams of vitamin C.

In some embodiments is provided a multiplex comestible product wherein the additional item is homogenized persea americana. Another embodiment provides a multiplex comestible product wherein the additional item is the aleurone and pericarp of a grain. Another embodiment provides a multiplex comestible product wherein the additional item is the aleurone and pericarp of a wheat grain. Another embodiment provides a multiplex comestible product wherein the additional items are homogenized persea americana and the aleurone and pericarp of a grain.

Another embodiment provides a multiplex comestible product wherein each apportionment comprises at least about two grams of fiber. Another embodiment provides a multiplex comestible product wherein each apportionment comprises at least about three grams of fiber. Another embodiment provides a multiplex comestible product wherein each apportionment comprises at least about four grams of fiber. Another embodiment provides a multiplex comestible product wherein each apportionment comprises at least about five grams of fiber.

Another embodiment provides a multiplex comestible product wherein each apportionment comprises at least about 2 milligrams of vitamin C. Another embodiment provides a multiplex comestible product wherein each apportionment comprises at least about 3 milligrams of vitamin C. Another embodiment provides a multiplex comestible product wherein each apportionment comprises at least about 4 milligrams of vitamin C. Another embodiment provides a multiplex comestible product wherein each apportionment comprises at least about 5 milligrams of vitamin C.

Another embodiment provides a multiplex comestible product wherein each apportionment comprises at least about two grams of fiber and at least about 5 milligrams of vitamin C. Another embodiment provides a multiplex comestible product wherein each apportionment comprises at least about three grams of fiber and at least about 2 milligrams of vitamin C.

Another embodiment provides a multiplex comestible product wherein each apportionment comprises from 200 to 350 kilocalories.

Another embodiment provides a multiplex comestible product wherein the product is exposed to a temperature of at least about 160° C. for at least about ten minutes. Another embodiment provides a multiplex comestible product wherein the product is exposed to a temperature of at least about 160° C. until a knife or wooden implement, after being inserted into the center of the product, comes out clean and/or the center of the product springs back when touched.

In some embodiments, disclosed herein is a multiplex comestible product comprising:
a. a chocolate flavoring;
b. an aqueous solution comprising homogenization of Malus domestica;
c. homogenized Phaseolus vulgaris; and
d. a sweetener;
   wherein the product is severable into at least about twenty apportionments of from 200 to 400 kilocalories, wherein each apportionment of the product comprises one or more of the following:
a) at least about two grams of fiber;
b) at least about 5 milligrams of vitamin C; and
c) at least about 5 grams of protein.

Another embodiment provides a multiplex comestible product further comprising a homogenization of arachis hypogaea.

Another embodiment provides a multiplex comestible product wherein each apportionment comprises at least about two grams of fiber. Another embodiment provides a multiplex comestible product wherein each apportionment comprises at least about three grams of fiber. Another embodiment provides a multiplex comestible product wherein each apportionment comprises at least about four grams of fiber. Another embodiment provides a multiplex comestible product wherein each apportionment comprises at least about five grams of fiber. Another embodiment provides a multiplex comestible product wherein each apportionment comprises at least about six grams of fiber.

Another embodiment provides a multiplex comestible product wherein each apportionment comprises at least about 5 milligrams of vitamin C. Another embodiment provides a multiplex comestible product wherein each apportionment comprises at least about 6 milligrams of vitamin C. Another embodiment provides a multiplex comestible product wherein each apportionment comprises at least about 7 milligrams of vitamin C.

Another embodiment provides a multiplex comestible product wherein each apportionment comprises at least about 5 grams of protein. Another embodiment provides a multiplex comestible product wherein each apportionment comprises at least about 6 grams of protein.

Another embodiment provides a multiplex comestible product wherein each apportionment comprises at least about three grams of fiber, at least about 7 milligrams of vitamin C, and at least about 6 grams of protein.

Another embodiment provides a multiplex comestible product wherein the product is exposed to a temperature of at least about 160° C. for at least about ten minutes. Another embodiment provides a multiplex comestible product wherein the product is exposed to a temperature of at least about 160° C. until a knife or wooden implement, after being inserted into the center of the product, comes out clean and/or the center of the product springs back when touched.

One embodiment provides a process to produce a multiplex comestible product comprising admixing the following components:
a. a chocolate flavoring;
b. an aqueous solution comprising homogenization of desiccated prunus domestica;
c. an additional item selected from homogenized persea americana, and/or the aleurone and pericarp of a grain; and
d. a sweetener;
   and severing the product into at least about twenty apportionments of from 200 to 400 kilocalories, such that each apportionment of the product comprises one or more of the following:
a) at least about two grams of fiber; and
b) at least about 2 milligrams of vitamin C.

In some embodiments is provided a process wherein the additional item is homogenized persea americana. In some embodiments is provided a process wherein the additional item is the aleurone and pericarp of a grain. Another embodiment provides a process wherein the additional item is the aleurone and pericarp of a wheat grain. Another embodiment provides a process wherein the additional items are homogenized persea americana and the aleurone and pericarp of a grain.

Another embodiment provides a process wherein each apportionment comprises at least about two grams of fiber. Another embodiment provides a process wherein each apportionment comprises at least about three grams of fiber. Another embodiment provides a process wherein each apportionment comprises at least about four grams of fiber. Another embodiment provides a process wherein each apportionment comprises at least about five grams of fiber.

Another embodiment provides a process wherein each apportionment comprises at least about 2 milligrams of vitamin C. Another embodiment provides a process wherein each apportionment comprises at least about 3 milligrams of vitamin C. Another embodiment provides a process wherein each apportionment comprises at least about 4 milligrams of vitamin C. Another embodiment provides a process wherein each apportionment comprises at least about 5 milligrams of vitamin C.

Another embodiment provides a process wherein each apportionment comprises at least about two grams of fiber and at least about 5 milligrams of vitamin C. Another embodiment provides a process wherein each apportionment comprises at least about three grams of fiber and at least about 2 milligrams of vitamin C.

Another embodiment provides a process wherein each apportionment comprises from 200 to 350 kilocalories.

Another embodiment provides a process wherein the product is exposed to a temperature of at least about 160° C. for at least about ten minutes. Another embodiment provides a process wherein the product is exposed to a temperature of at least about 160° C. until a knife or wooden implement, after being inserted into the center of the product, comes out clean and/or the center of the product springs back when touched.

One embodiment provides a process to produce a multiplex comestible product comprising admixing the following components:
a. a chocolate flavoring;
b. an aqueous solution comprising homogenization of Malus domestica;
c. homogenized Phaseolus vulgaris; and
d. a sweetener;
   and severing the product into at least about twenty apportionments of from 200 to 400 kilocalories, such that each apportionment of the product comprises one or more of the following:
a) at least about two grams of fiber;
b) at least about 5 milligrams of vitamin C; and
c) at least about 5 grams of protein.

Another embodiment provides a process wherein the product further comprises a homogenization of arachis hypogaea.

Another embodiment provides a process wherein each apportionment comprises at least about two grams of fiber. Another embodiment provides a process wherein each apportionment comprises at least about three grams of fiber. Another embodiment provides a process wherein each apportionment comprises at least about four grams of fiber. Another embodiment provides a process wherein each apportionment comprises at least about five grams of fiber. Another embodiment provides a process wherein each apportionment comprises at least about six grams of fiber.

Another embodiment provides a process wherein each apportionment comprises at least about 5 milligrams of vitamin C. Another embodiment provides a process wherein each apportionment comprises at least about 6 milligrams of vitamin C. Another embodiment provides a process wherein each apportionment comprises at least about 7 milligrams of vitamin C.

Another embodiment provides a process wherein each apportionment comprises at least about 5 grams of protein. Another embodiment provides a process wherein each apportionment comprises at least about 6 grams of protein.

Another embodiment provides a process wherein each apportionment comprises at least about three grams of fiber, at least about 7 milligrams of vitamin C, and at least about 6 grams of protein.

Another embodiment provides a process wherein the product is exposed to a temperature of at least about 160° C. for at least about ten minutes. Another embodiment provides a process wherein the product is exposed to a temperature of at least about 160° C. until a knife or wooden implement, after being inserted into the center of the product, comes out clean and/or the center of the product springs back when touched.

One embodiment provides a method of increasing fiber intake in an individual in need thereof comprising administering a multiplex comestible product as described herein to the individual. Another embodiment provides a method wherein the individual is below the age of 18 years or above the age of 65 years. Another embodiment provides a method wherein the individual is below the age of 18 years. Another embodiment provides a method wherein the individual is at or above the age of 65 years.

In some embodiments, commercially available mixes are used to prepare the multiplex products disclosed herein. In some embodiments, the individual components of these mixes can be combined prior to use in the preparation of the multiplex products disclosed herein.

### EXAMPLES

### Example 1

### High Fiber Brownies

48 servings, 325 calories/serving, 2 grams fiber, 85 IU vitamin A, 5 units vitamin C

| Amount | Components |
|---|---|
| 5 pounds | brownie mix |
| 2.5 cups | prune juice |
| 2 cups | bran flakes, coarsely crushed |
| 2 cups | chocolate chips |
| 2 cups | granola (no raisins) |

Brownie mix, juice and crushed bran flakes were homogenized at low speed to a smooth consistency. The mixture was transferred to shallow containers and topped with granola before heat treatment at 350° F. for 10-12 minutes.

### Example 2

### Chocolate Cake

38×(4 oz serving); 379 calories/serving; 3 grams fiber, 15 IU vitamin A, 2 units of vitamin C

| Amount | Components |
|---|---|
| 5 pounds | chocolate cake mix |
| 6 cups | prune juice |
| 2 cups | avocado, pureed |
| 2 cups | chocolate chips |
| As needed | powdered sugar |
| As needed | chocolate, melted |

Cake mix and half of the prune juice were combined until a smooth consistency was obtained. The avocado and remaining juice were added, and the mixture was homogenized at medium speed. Chocolate chips were incorporated at low speed. The resultant mixture was transferred into appropriately sized containers before heat treatment at 350° F. for 15-18 minutes. The final product was lightly covered with powdered sugar and melted chocolate prior to serving.

### Example 3

### High Protein Brownie

48 servings; 354 calories/serving, 3 grams fiber, 2 IU vitamin A, 7 units vitamin C

| Amount | Components |
|---|---|
| 5 pounds | brownie mix |
| 2.5 cups | apple juice |
| 2 cups | black beans, pureed |
| 2 cups | chocolate chips |
| As needed | powdered sugar |
| As needed | water (optional) |
| As needed | peanut butter (optional) |

Black beans were homogenized to a smooth texture using some apple juice as needed. Brownie mix and the remaining apple juice were added to the black beans, and the resultant mixture was homogenized at low speed. Further homogenization was performed after the addition of chocolate chips prior to transfer of the mixture to shallow pans. Heat treatment at 350° F. for 10-12 minutes followed by a light topping of powdered sugar was conducted prior to serving. Alternatively, peanut butter and water (or apple juice) can be homogenized to a smooth consistency in order to be used as a topping prior to heat treatment.

### Example 4

### Peanut Butter and Jelly Muffin

˜3.25 oz (prior to heat treatment) serving size; 219 calories/serving, 1 gram fiber, 100 IU vitamin A, 5 units vitamin C

| Amount | Components |
|---|---|
| 5 pounds | muffin mix |
| 5 cups | apple juice |
| 2 cups | peanut butter |
| As needed | raspberry preserves |

Peanut butter and apple juice were homogenized prior to the addition of muffin mix. Homogenization was continued until a smooth texture was obtained. The resultant mixture was transferred into appropriately sized containers and optionally lightly topped with raspberry preserves prior to heat treatment at 350° F. for about 15 minutes.

### Example 5

### Strawberry Pound Cake Muffin

32×(3 oz serving);

| Amount | Components |
|---|---|
| 5 pounds | pound cake mix |
| 4 cups | apple juice |
| 32 each | Strawberries, small & whole, leaves & stem removed |
| As needed | pan spray |

Pre-sifted pound cake mix and apple juice were combined until a smooth consistency was obtained. Appropriately sized containers were pre-treated with pan spray prior to the transfer of the mixture to these containers. One strawberry was submerged point up into each single-serving container of mixture. These final mixtures were heat treated at 325° F. for 16-18 minutes.

### Example 6

### Oat Bran and Raisin Muffin

32×(3 oz serving);

| Amount | Components |
|---|---|
| 5 pounds | oat bran muffin mix |
| 5½ cups | apple juice |
| 4 cups | raisins |
| ⅔ cup | oats |
| 4 Tbsp | cinnamon and sugar |
| As needed | pan spray |

Pre-sifted oat bran muffin mix and apple juice were combined until a smooth consistency was obtained. After the addition of the raisins, the mixture was further homogenized. Appropriately sized containers were pre-treated with pan spray prior to the transfer of the mixture to these containers. The single size servings were lightly topped with oats and the cinnamon and sugar mix prior to heat treatment at 350° F. for 18-20 minutes.

### Example 7

### Sweet Potato Pancakes

68×(3 oz serving); 413 calories/serving, 1 gram fiber, 19 units vitamin C

| Amount | Components |
|---|---|
| 14 cups | multigrain pancake mix |
| 12 cups | water |
| 3 cups | sweet potato, pureed |
| 4 tsp | cinnamon |
| ½ tsp | ginger |

All components were combined and homogenized until a smooth texture was obtained. Four-ounce portions of the mixture were heated for 3-5 minutes on a surface pre-treated with pan spray until the mixture solidified.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-6. (canceled)

7. A process for producing a comestible product comprising admixing the following components:
a chocolate flavoring;
an aqueous solution comprising homogenization of Malus domestica;
homogenized Phaseolus vulgaris; and
a sweetener;
and severing the product into at least about twenty apportionments of from 200 to 400 kilocalories, wherein each apportionment of the product comprises one or more of the following:
at least about two grams of fiber; and
at least about 5 milligrams of vitamin C; and
at least about 5 grams of protein; wherein the product is appeasing in texture, taste, and appearance.

8. The process according to claim 7 wherein each apportionment comprises at least about 6 grams of protein.

9. The process according to claim 7 wherein each apportionment comprises at least about 6 milligrams of Vitamin C.

10. The process according to claim 7, wherein the product is exposed to a temperature of at least about 160° C. for at least about ten minutes.

11. The process according to claim 7, further comprising a homogenization of arachis hypogaea.

12. A process to produce a comestible product comprising admixing the following components:
a chocolate flavoring;
an aqueous solution comprising homogenization of desiccated prunus domestica; and
homogenized persea americana; and
a sweetener;
and severing the product into at least about twenty apportionments of from 200 to 400 kilocalories, such that each apportionment of the product comprises one or more of the following:
at least about two grams of fiber; and
at least about 2 milligrams of vitamin C; wherein the product is appeasing in texture, taste, and appearance.

13. The process of claim 12, wherein the additional item is homogenized persea americana.

14. (canceled)

15. The process of claim 12, wherein each apportionment comprises at least about three grams of fiber.

16. The process of claim 12, wherein each apportionment comprises from 200 to 350 kilocalories.

17. A method of increasing fiber intake in an individual in need thereof comprising administering a product of claim 1 to the individual.

18. The method of claim 17, wherein the individual is below the age of 18 years or above the age of 65 years.

19. A method of increasing fiber intake in an individual in need thereof comprising administering a product of claim 7 to the individual.

20. The method of claim 19, wherein the individual is below the age of 18 years or above the age of 65 years.
